(19) United States
(12) Patent Application Publication
(10) Pub. No.: US 2020/0030903 A1
(43) Pub. Date: Jan. 30, 2020

(54) SYSTEMS AND METHODS FOR POSITIONING A PLURALITY OF SPHERES

(71) Applicant: Trans-Tec America, LLC, Chandler, AZ (US)

(72) Inventor: Steven C. Barkus, Prescott, AZ (US)

(21) Appl. No.: 16/518,036

(22) Filed: Jul. 22, 2019

Related U.S. Application Data
(60) Provisional application No. 62/702,757, filed on Jul. 24, 2018.

(51) Int. Cl. B23K 3/06

(52) U.S. Cl. CPC B23K 3/0623

(57) ABSTRACT

An apparatus for the presentation of solder spheres to one or more pickup locations of assembly equipment simultaneously. An exemplary method conveys spherical material from a bulk reservoir by the use of a vacuum ported rotating cylinder with a number of apertures. Apertures in the rotating cylinder correspond with pickup locations on a host machine.

### CROSS-REFERENCE TO RELATED APPLICATIONS

This application is a non-provisional of, and claims priority to, U.S. Ser. No. 62/702,757 filed on Jul. 24, 2018 and entitled “SYSTEMS AND METHODS FOR POSITIONING A PLURALITY OF SPHERES.” The contents of the foregoing application are hereby incorporated by reference in their entirety for all purposes.

### TECHNICAL FIELD

The present disclosure relates to electronics assembly, and in particular to supply and positioning of components associated with the interconnect surface of a Ball Grid Array (BGA).

### BACKGROUND

The bottom or interconnect side of a Ball Grid Array is comprised of solder spheres. The construction of this array of solder spheres has required specialized equipment and processes to assemble.

Currently, there exists a multitude of dedicated equipment and processes for the construction of the interconnect surface of Ball Grid Array devices. In recent years surface mount equipment has increased in capability to handle smaller components. This advance in technology has brought about the use of surface mount equipment to assemble the top side of BGA devices, while requiring separate and specialized equipment to create the array of solder balls for the bottom of the device. Accordingly, improved systems and methods for supplying and/or positioning components, for example solder spheres, for use in connection with a ball grid array remain desirable.

### SUMMARY

In an exemplary embodiment, an apparatus for conveying a plurality of solder spheres to a host machine comprises a body having a basin therein, the basin at least partially filled with the plurality of solder spheres; a hollow, rotatable cylinder disposed at least partially within the basin, the rotatable cylinder configured with a set of apertures therethrough; a rotation mechanism coupled to the cylinder; and a vacuum source coupled to an inner chamber of the hollow cylinder.

In another exemplary embodiment, a method of conveying a plurality of solder spheres to a host machine comprises disposing, in a basin, a plurality of solder spheres; rotating a cylinder having a plurality of apertures therethrough to cause a first set of solder spheres to removably adhere to the apertures; and rotating the cylinder to position the first set of solder spheres at top dead center of the cylinder.

The contents of this summary section are to be understood as a simplified introduction to the disclosure, and are not intended to be used to limit the scope of any claim.

### BRIEF DESCRIPTION OF THE DRAWINGS

With reference to the following description, appended claims, and accompanying drawings:

FIG. 1 illustrates an exemplary ball feeder, showing a basin filled with solder spheres and a rotatable cylinder partially submerged in the spheres, in accordance with an exemplary embodiment;

FIG. 2 illustrates a cross-sectional view of an exemplary ball feeder taken along line 2-2 of FIG. 1, the cross-section taken at a position where a solder sphere is located at top dead center on the rotatable cylinder and thus ready to be picked by a host machine, in accordance with an exemplary embodiment; and

FIG. 3 illustrates a configuration of an exemplary rotatable cylinder in accordance with an exemplary embodiment.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

For the sake of brevity, conventional techniques for pick and place assembly, surface mount construction, integrated circuit fabrication, packaging, and assembly, and/or the like, may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical system or related methods of use, for example a ball feeder system.

Various shortcomings of prior pick and place systems, manufacturing systems utilizing ball grid arrays, and/or the like can be addressed by utilizing a ball feeder system configured in accordance with principles of the present disclosure. For example, the present system improves upon existing technology by presenting multiple solder spheres to multiple pickup locations on any multi head pick and place machine regardless of head spacing on the host machine. Currently there exist two primary means of presenting solder balls to a pick and place machine: one is to have the solder balls packaged in traditional tape and reel format; the second is to use a vibratory bowl to singulate and feed solder balls. In the case of packaging the balls in tape and reel the cost of the packaging operation is 5 to 10 times the cost of the solder sphere. Limitations of the vibratory bowl feeders include the size of the bowl and the number of heads that can be supplied in proximity to one another simultaneously.

A ball feeder system in accordance with principles of the present disclosure may be configured with any suitable components, structures, and/or elements in order to provide desired mechanical, positional, electrical, and/or chemical properties or functions. The exemplary apparatus and methods of supplying multiple solder balls to a pick and place machine from a bulk reservoir eliminates the need for packaging solder balls in a conventional fashion, and also facilitates the simultaneous acquisition of multiple solder balls by the host machine.

Modern pick and place machines used in electronics assembly have multiple heads to handle several components in one cycle of picking and placing components. To capitalize on this capability, an exemplary ball feeder system is capable of supplying a solder sphere 16 to every head on the pick and place machine in a single pick cycle. Via use of this ball feeder system, multiple spheres may be supplied to multiple heads from a bulk supply in a quick and efficient matter. In this manner, operation, accuracy, and/or speed of the pick and place machine may be improved.

Additionally, in various exemplary embodiments a ball feeder system as disclosed herein may be utilized in connection with through-hole reflow applications, for example by replacing solder preforms with solder spheres. Solder preforms have been utilized in the surface mount industry to address a variety of SMT soldering challenges. However, solder preforms are costly and require dedicated packaging and feeders. Accordingly, principles of the present disclosure contemplate use of an exemplary ball feeder system to supplement the volume of solder needed for through-hole reflow applications and supporting components during the initial stages of reflow and replacing solder preforms with solder spheres in a cost effective manner for many applications. Moreover, principles of the present disclosure contemplate use of a ball feeder system in any suitable industrial application.

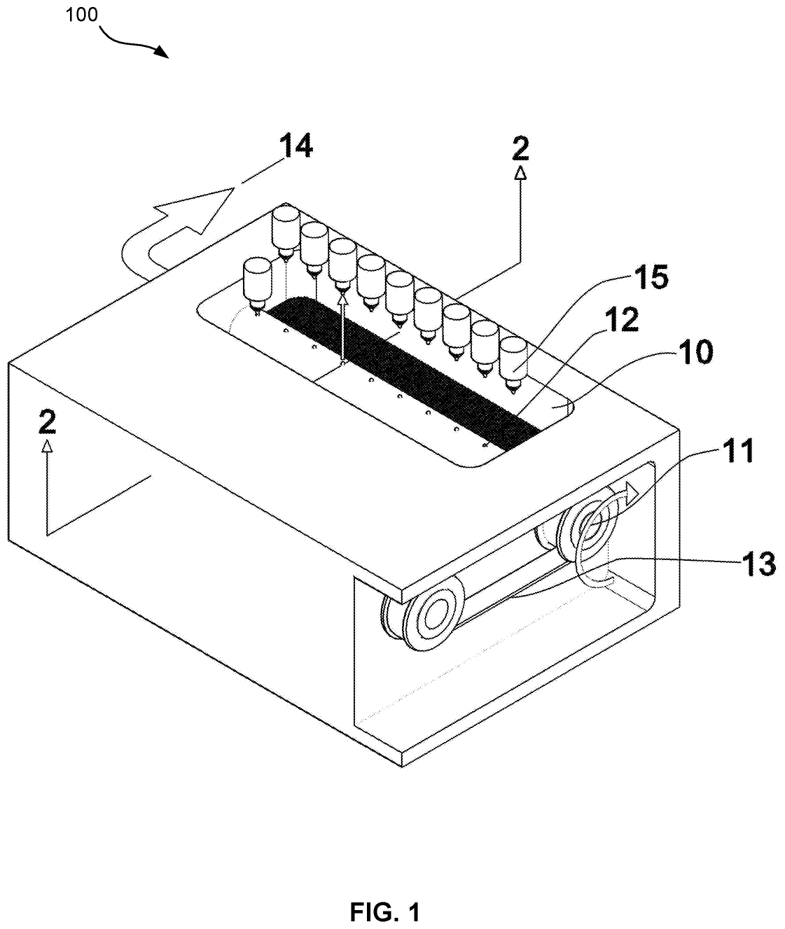

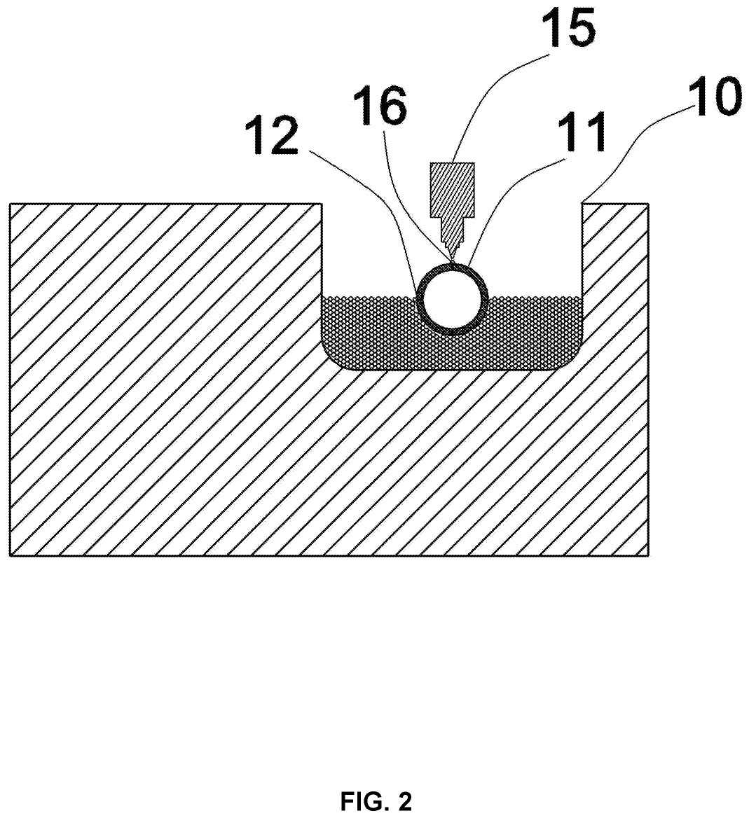

With reference now to FIG. 1 and FIG. 2, in an exemplary embodiment a ball feeder system 100 comprises a housing configured with a basin 10 having a plurality of solder spheres 16 placed therein. Disposed at least partially within the basin is a rotatable cylinder 11 having apertures 12 that port vacuum from the inside of the cylinder 11 through to the outside surface of cylinder 11. Any suitable number and/or configuration of apertures 12 may be utilized. In one exemplary embodiment, cylinder 11 is configured with 10 apertures 12 disposed in a row thereon, the row extending down cylinder 12 in a manner parallel to the axis of rotation. Cylinder 11 may be any suitable size, for example based at least in part on dimensions of objects to be placed in basin 10. For example, cylinder 11 may have a diameter of between about 6 mm and about 300 mm. In one exemplary embodiment, cylinder 11 has a diameter of 75 mm. In another exemplary embodiment, cylinder 11 has a diameter of 13 mm. In some exemplary embodiments, cylinder 11 has a diameter of between about 10 mm and about 30 mm.

Solder spheres 16 may be any suitable size, for example having a diameter of 0.0157″, 0.02″, 0.024″, 0.028″, 0.03″, 0.035″, 0.062″, and/or the like. However, any suitable size of solder spheres 16 may be utilized. Moreover, the dimensions of apertures 12 may be selected based at least in part on the diameter of a solder sphere 16 intended for use. Stated another way, apertures 12 may be sized to prevent solder spheres 16 from passing through apertures 12 while still being sufficiently large to permit pickup of solder spheres 16 responsive to a vacuum force therethrough.

In some exemplary embodiments, rotatable cylinder 11 may be swappable within ball feeder system 100, such that a particular rotatable cylinder 11 may be installed when ball feeder system 100 is utilized in connection with a first size of solder spheres 16, and a different rotatable cylinder 11 having a different aperture 12 size may be utilized in connection with use of a second, different size of solder spheres 16.

Additionally, in some exemplary embodiments rotatable cylinder 11 comprises an outer cylinder 11A and an inner cylinder 11B that are indexable with respect to one another. Outer cylinder 11A may have multiple sets of apertures 12 therethrough. For example, outer cylinder 11A may have a first set of apertures 12 sized for use with solder spheres of 0.035″ diameter, and a second set of apertures 12 sized for use with solder spheres of 0.062″ diameter. Rotatable cylinder 11 may also comprise an inner cylinder 11B having multiple sets of apertures 12 therethrough. The placement and size of apertures 12 on outer cylinder 11A and inner cylinder 11B may be such that, when outer cylinder 11A and inner cylinder 11B are indexed to a first orientation, a first set of apertures 12 in outer cylinder 11A aligns with a first set of apertures 12 in inner cylinder 11B of common size, while no other set of apertures 12 in either outer cylinder 11A or inner cylinder 11B align with one another. Similarly, when outer cylinder 11A and inner cylinder 11B are indexed to a second orientation, a second set of apertures 12 in outer cylinder 11A aligns with a second set of apertures 12 in inner cylinder 11B of common size, while no other set of apertures 12 in either outer cylinder 11A or inner cylinder 11B align with one another. In this manner, rotatable cylinder 11 may be reconfigurable to function with solder spheres 16 of various sizes while avoiding pick-up of any solder spheres 16 at undesired locations.

In another exemplary embodiment, rotatable cylinder 11 comprises an outer cylinder 11A and an inner cylinder 11B that are indexable with respect to one another. Outer cylinder 11A has multiple sets of apertures 12 therethrough (with each set sized for use with a particular size of solder sphere 16), while inner cylinder 11B has a single set of apertures 12 therethrough. Apertures 12 in inner cylinder 11B may be larger than (or at least as large as the largest of) any apertures 12 in outer cylinder 11A. As outer cylinder 11A and inner cylinder 11B are indexed with respect to one another, apertures 12 in inner cylinder 11B may come into alignment with one set of apertures 12 in outer cylinder 11A (but no other apertures 12 in outer cylinder 11A), thus configuring rotatable cylinder 11 for use with a particular size of solder sphere 16. When use of a new size of solder sphere 16 is desired, outer cylinder 11A and inner cylinder 11B are re-indexed to the appropriate orientation to align the desired corresponding apertures 12.

In operation of system 100, basin 10 may be at least partially filled with solder spheres 16, for example to a level at least as high as the bottom of rotatable cylinder 12. Solder spheres 16 may be added to basin 10 as desired, for example via a continuous gravity feed system, via emptying a container of solder spheres 16 into basin 10 in an intermittent manner, and/or the like. When cylinder 11 is indexed and vacuum is supplied thereto, apertures 12 will pick up and transport solder spheres 16 to a desired position, for example positions at top dead center. Cylinder 11 may be rotated/indexed via any suitable mechanism, for example a belt drive 13, a directly coupled electric motor, a chain drive, a gear drive, and/or the like. Moreover, cylinder 11 may be supplied with vacuum 14 via any suitable source, for example via a vacuum tube coupled to a pump.

When a group of solder spheres 16 are positioned at top dead center responsive to operation of system 100, portions of a pick and place machine 15 may approach and retrieve solder spheres 16. System 100 may then re-rotate cylinder 11 in order to bring a new group of solder spheres 16 to a desired position, for example top dead center, in preparation for the next “pick” by pick and place machine 15. The process may be repeated, as desired, in order to supply any desired number and/or arrangement of solder spheres for pick and place machine 15.

In some exemplary embodiments, vacuum may be supplied to cylinder 11 in a continuous manner. Alternatively, the supply of vacuum to cylinder 11 may be temporarily interrupted, for example when a group of solder spheres 16 are positioned at top dead center and awaiting retrieval by pick and place machine 15.

In some exemplary embodiments, cylinder 11 may comprise a first set of apertures 12 in a first row along cylinder 11, and a second set of apertures 12 in a second row disposed on the opposite side of cylinder 11 (i.e., 180 degrees apart). In this manner, system 100 may deliver a set of solder spheres 16 to top dead center for every half-rotation of cylinder 11, thus providing solder spheres 16 at a faster pace to a corresponding pick and place machine 15. In another exemplary embodiment, cylinder 11 comprises three sets of apertures 12, separated by 120 degrees around cylinder 11, thus being operative to provide a set of solder spheres 16 to top dead center for every one-third rotation of cylinder 11. In some exemplary embodiments, cylinder 11 may comprise four sets of apertures 12 separated by 90 degrees, five sets of apertures 12 separated by 72 degrees, and/or any suitable number of sets of apertures 12, as desired, with appropriate spacing therebetween. Moreover, the location and number of apertures 12 in cylinder 11 may be selected based at least in part on a desired rotation speed of cylinder 11, a desired interval between pickups by pick and place machine 15, size and/or materials of solder spheres 16, vibration and/or isolation concerns associated with operation of system 100, and/or the like.

In various exemplary embodiments, during operation of system 100 cylinder 11 may be rotated at a suitable speed in order to capture solder spheres 16 and separate them from solder spheres 16 remaining in basin 10. In an exemplary embodiment, cylinder 11 is rotated at a speed of 50 RPM. In another exemplary embodiment, cylinder 11 is rotated at a speed of 60 RPM. In various exemplary embodiments, cylinder 11 is rotated at a speed of between about 45 RPM and about 70 RPM.

Cylinder 11 may be rotated at a constant speed; alternatively, cylinder 11 may be accelerated and/or decelerated, as desired, including coming to a complete stop for a period or periods during a single rotation of cylinder 11, in order to capture and relocate solder spheres 16. For example, cylinder 11 may be operated with an acceleration and deceleration period of between about 25 milliseconds and about 50 milliseconds in order to provide sufficient time for the inertia of moving solder spheres 16 to not overcome the force of the vacuum retaining them against cylinder 11.

In various exemplary embodiments, system 100 may be constructed with a CPM-SDSK-2310S-ELN servo motor and IPC-3 power supply offered by Teknic, Inc. (Victor, N.Y.). In this exemplary embodiment, system 100 may be controlled via use of an ACE11 programmable logic controller (PLC) offered by Velocio Networks (Huntsville, Ala.). However, any suitable components may be utilized, as desired.

In various exemplary embodiments, system 100 may be compatible with and/or work in connection with various pick and place machines, for example any multi head SMT pick and place machine built by Yamaha (YSM10/YSM20), IPulse (M10/M20) Juki (RX-6/FX-3), Universal instruments (GSM), and/or the like.

In some exemplary embodiments, system 100 may be utilized in connection with basin 10 being filled with one or more of ball bearings, glass beads, round food items such as fruit, tennis balls or other types of balls, or any other object desired to be singulated for packaging or a similar process.

In other exemplary embodiments, system 100 may be utilized in connection with basin 10 being filled with one or more non-spherical objects (for example, rectangular shaped components such as resistors or capacitors that do not have polarity); in these exemplary embodiments, cylinder 11 may be configured with indentations, notches, bumps, recesses, or other surface features in order to facilitate alignment of the component to be picked up with cylinder 11 and/or an aperture 12. For example, when cylinder 11 is utilized to pick-up a square resistor having dimensions of approx. ¼″ by ¼″, cylinder 11 may be configured with a recess therein centered about aperture 12; the recess may have a dimension of about ¼″ by ¼″ at the bottom of the recess (i.e., generally corresponding to and slightly larger than the outer dimensions of the resistor), and the sides of the recess may taper outward slightly and feature a slightly rounded top lip. As cylinder 11 rotates through basin 10, vacuum force through aperture 12 will cause a resistor to be “sucked” into the recess and thus assume a desired alignment.

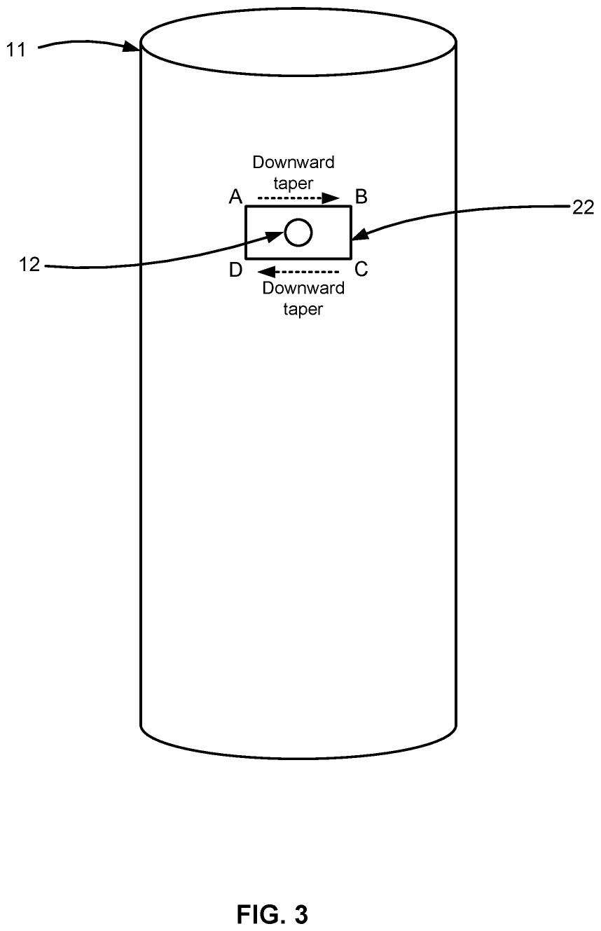

In some exemplary embodiments, with reference now to FIG. 3, when system 100 is utilized in connection with basin 10 being filled with certain non-spherical objects (for example rectangular objects, triangular objects, and/or the like), various indentations, notches, bumps, recesses, or other surface features on cylinder 11 may be provided in order at least partially rotate and/or align the objects as they are picked up by cylinder 11 via operation of apertures 12. For example, cylinder 11 may be configured with a recess 22 around and/or centered about each aperture 12; the recess may be configured with one or more “ramp”-like or otherwise tapering sides. For example, recess 22 may generally taper downward along side AB of recess 22, with a high point at corner A and a low point at corner B. Likewise, recess 22 may generally taper downward along side CD of recess 22, with a high point at corner C and a low point at corner D. In this manner, as an object is urged against and/or into recess 22 via vacuum force arising from aperture 12, the object may be caused to rotate in a plane normal to the surface of cylinder 11 due to the engagement with the tapering sides, eventually assuming a desired orientation as the object reaches the bottom of recess 22. Recess 22 may have straight and/or linear tapering side(s); alternatively, recess 22 may have curved tapering sides. For example, in one embodiment recess 22 is configured with a circular top opening having a diameter exceeding the longest dimension of a target object, a bottom surface having a shape (e.g., a rectangle) corresponding to and slightly larger than the shape of the object, and an inner tapered surface configured to cause the object to rotate as it descends into recess 22.

In this manner, system 100 may be utilized to streamline and/or facilitate improved manufacturing and/or assembly processes, both for spherical-type objects as well as for certain objects having non-spherical shapes.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, a thermal connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. An apparatus for conveying a plurality of solder spheres to a host machine, the apparatus comprising:
a body having a basin therein, the basin at least partially filled with the plurality of solder spheres;
a hollow, rotatable cylinder disposed at least partially within the basin, the rotatable cylinder configured with a set of apertures therethrough;
a rotation mechanism coupled to the rotatable cylinder; and
a vacuum source coupled to an inner chamber of the rotatable cylinder.

2. The apparatus of claim 1, wherein the rotation mechanism comprises an electric motor.

3. The apparatus of claim 1, wherein the rotation mechanism comprises a pneumatic connection from the host machine.

4. The apparatus of claim 1, wherein the rotation mechanism comprises a mechanical link from the host machine.

5. The apparatus of claim 1, wherein the vacuum source is electrically controlled.

6. The apparatus of claim 1, wherein the vacuum source is mechanically controlled by rotation of the rotatable cylinder.

7. The apparatus of claim 1, wherein the vacuum source is mechanically controlled by the host machine.

8. The apparatus of claim 1, wherein the vacuum source is mechanically controlled by the rotation mechanism.

9. The apparatus of claim 1, wherein the set of apertures in the rotatable cylinder are arranged in a line parallel to a rotational axis of the rotatable cylinder.

10. The apparatus of claim 1, wherein the rotatable cylinder comprises an outer cylinder and an inner cylinder that are indexable with respect to one another in order to form the set of apertures therethrough.

11. A method of conveying a plurality of solder spheres to a host machine, the method comprising:
disposing, in a basin, a plurality of solder spheres;
rotating a cylinder having a plurality of apertures therethrough to cause a first set of solder spheres to removably adhere to the apertures; and
rotating the cylinder to position the first set of solder spheres at top dead center of the cylinder.

12. The method of claim 11, wherein the cylinder is supplied with a vacuum force to cause the first set of solder spheres to removably adhere to the apertures.

13. The method of claim 11, further comprising:
terminating the vacuum force to release the solder spheres from the apertures; and
removing, by a pick and place machine, the solder spheres from the apertures.

14. The method of claim 13, further comprising:
supplying the cylinder with a vacuum force; and
rotating the cylinder to cause a second set of solder spheres to removably adhere to the apertures.
